(19) United States
(12) Patent Application Publication
(10) Pub. No.: US 2003/0224116 A1
(43) Pub. Date: Dec. 4, 2003

(54) Non-conformal overcoat for nonometer-sized surface structure

(76) Inventors: Erli Chen, Belle Mead, NJ (US); Stephen Y. Chou, Princeton, NJ (US)

Correspondence Address: PENNIE AND EDMONDS, 1155 AVENUE OF THE AMERICAS, NEW YORK, NY, 100362711

(21) Appl. No.: 10/158,024

(22) Filed: May 30, 2002

(51) Int. Cl. B05D 1/36

(52) U.S. Cl. 427/402

(57) ABSTRACT

A method for non-conformally coating nanometer-sized surface structures includes directing the overcoat material at an oblique angle onto a substrate having a nanometer-sized surface structure so that the overcoat material is only deposited substantially on the top portions of the nanometer-sized surface structures without filling the gaps between the nanometer-sized surface structures. Because the overcoat material is deposited onto the nanometer-sized surface structures obliquely, the overcoat material gradually closes the gaps between the nanometer-sized surface structures and form a continuous layer over the nanometer-sized surface structures.

### FIELD OF THE INVENTION

The present invention generally relates to providing a protective coating on nanometer-sized surface structures using a non-conformal deposition process.

### BACKGROUND OF THE INVENTION

As micro-processing technology advances, it becomes possible to manufacture components with surface structures as small as ten to hundreds of nanometers. FIGS. 1a-1c illustrate some examples of typical nanometer-sized surface structures. More advanced components may have multiple layers of the nanometer-sized surface structures.

A problem with most nanometer-sized surface structure is that they are very fragile and therefore susceptible to damage. Moreover, because of their relatively small topography, nanometer-sized surface structures are easily contaminated but difficult to clean. Furthermore, optical components having nanometer-sized surface structures, such as thin film wire grid polarizers have high insertion losses in either reflection or transmission, caused by the mismatch in the index of refraction between the device's surface and its environment, typically the atmosphere.

Thus, there is a need for a method of depositing a non-conforming continuous overcoat layer over a surface having nanometer-sized surface structures to protect such fragile surface structures and also improve their optical characteristics.

### SUMMARY OF THE INVENTION

The invention provides a method of coating nanometer-sized surface structures with a protective overcoat using a non-conformal deposition process in which an overcoat material is directed at the surface structures at an oblique deposition angle until the overcoat material forms a continuous layer of overcoat material bridging over the gaps between the nanometer-sized surface structures without filling the gaps.

The deposition angle is measured from an axis normal to the substrate surface bearing the nanometer-sized surface structures. The deposition angle may be selected to be between zero and 90 degrees and should be sufficiently large that the overcoat material does not deposit into the gaps between the nanometer-sized surface structure. Hence, the particular deposition angle to be used in a given application will depend on the width of the gaps between the nanometer-sized surface structures.

The final surface of the overcoat layer is relatively flat and smooth compared to un-coated nanometer-sized surface structures. The overcoat not only provides surface protection but also may modify or enhance the functional performance of the device, such as, its reflectivity, transmittance, operating bandwidth, acceptance angle, resonance, etc.

In accordance with another embodiment of the invention, a layer of seeding material is added to the top of the nanometer-sized surface structures prior to overcoating. The seed layer is added to provide such enhancements as an adhesion promoter, a diffusion barrier, and a corrosion barrier at the interface between the overcoat layer and the nanometer-sized surface structures. The seed layer may be deposited onto the nanometer-sized surface patterns in advance of the overcoat material using the same non-conformal deposition process. The seed layer may be a metal or a dielectric material and the selection of a particular material for the seed layer is determined by the purpose of the particular seed layer. The seed layer may be single-layered or multilayered. Alternatively, the seed layer is provided as part of the nanometer-sized surface structures.

### BRIEF DESCRIPTION OF THE DRAWINGS

For a better understanding of the invention, reference should be made to the following detailed description taken in conjunction with the accompanying drawings, in which:

FIGS. 1a-1c illustrate some examples of typical nanometer-sized surface structures;

FIG. 2a illustrates a cross-sectional view of an overcoat layer coated over nanometer-sized surface structures according to the present invention;

FIG. 2b illustrates a cross-sectional view of a multilayered overcoat structure with a single seed layer between the nanometer-sized surface structures and the overcoat structure;

FIGS. 3a-3c illustrate nanometer-sized surface structures at different stages during the process of non-conformal overcoating of the nanometer-sized surface structures according to the process of the present invention;

FIGS. 4a and 4b illustrate nanometer-sized surface structures at different stages during the process of bidirectional non-conformal deposition of the overcoat layer according to another embodiment of the process of the present invention;

FIGS. 5a-5c illustrate nanometer-sized surface structures at different stages during the process of rotational non-conformal deposition of the overcoat layer according to another embodiment of the process of the present invention;

FIG. 6 illustrates a two-layer seed formed during the last fabrication step of the nanometer-sized surface structures;

FIG. 7a-7c illustrate cross-sectional views of the seed layer being formed by different embodiments of the non-conformal deposition process according to the present invention; and

FIG. 8 illustrates a cross-sectional view of a single-layer overcoat deposited over a single-layer seed material where both the overcoat and the seed layer were non-conformally coated by the process according to the present invention.

The drawings are only schematic and are not to scale.

### DETAILED DESCRIPTION OF THE INVENTION

The following detailed description of the present invention is for illustrative purposes and should not be construed to limit the invention to these examples.

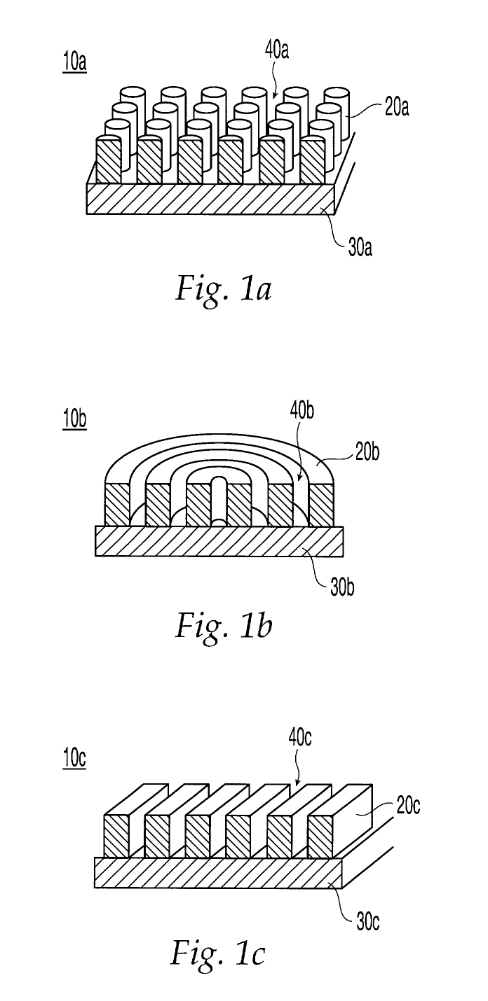

FIGS. 1a-1c illustrate typical devices 10a, 10b, and 10c having nanometer-sized surface structures 20a, 20b, and 20c, respectively, on which a layer of overcoat may be deposited using the method of the present invention. Typically, nanometer-sized surface structures 20a, 20b, and 20c are formed on substrates 30a, 30b, and 30c, respectively, in a regularly spaced pattern with gaps 40a, 40b, and 40c between each element of the pattern. The spacing of adjacent structures 20a, 20b, and 20c is typically in the range of ten to three-hundred nanometers.

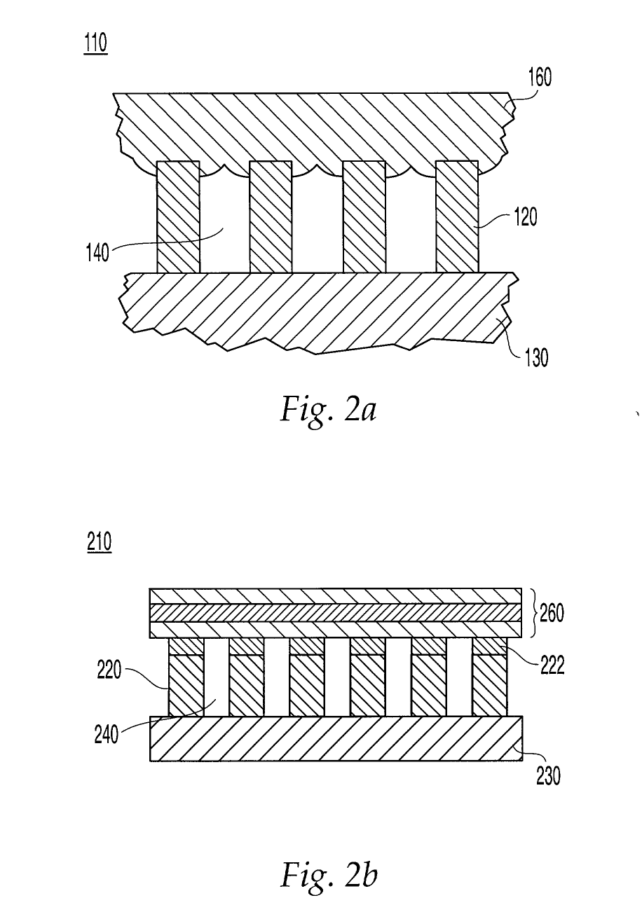

FIG. 2a illustrates a cross-sectional view of a typical device 110 of the present invention having nanometer-sized surface structures 120 onto which an overcoat layer 160 has been deposited. The structures are separated by gaps 140. FIG. 2b illustrates a cross-sectional view of a device 210 having nanometer-sized surface structures 220 that is coated with an overcoat layer 260 using another embodiment of the invention where the resulting overcoat layer is a multilayered structure. Again, the elements of the nanometer-sized surface structures 220 are separated by gaps 240. In this embodiment, a seed layer 222 is provided between the nanometer-sized surface structures 220 and the overcoat layer 260.

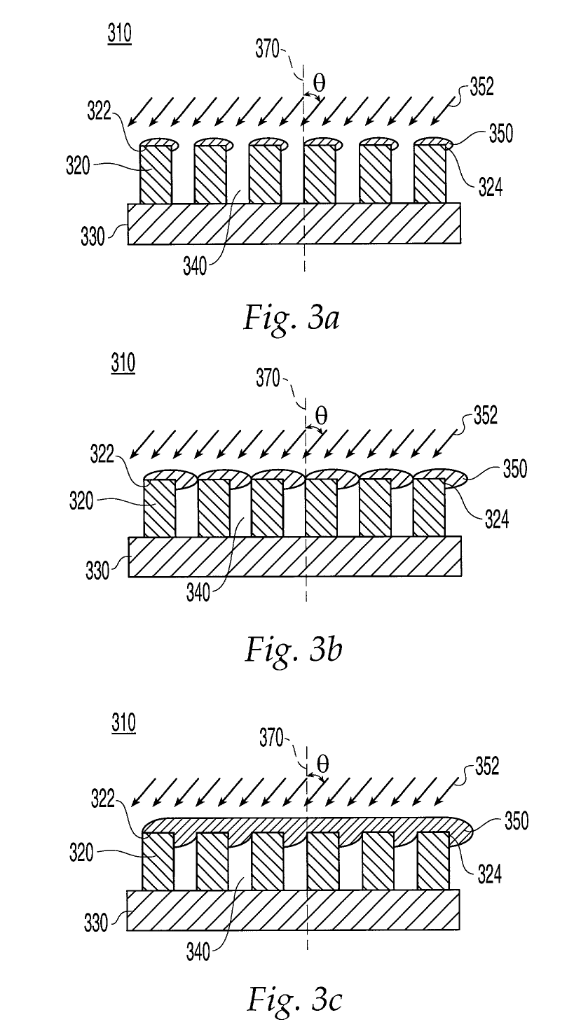

FIGS. 3a-3c illustrate a device 310 having a nanometer-sized surface structures 320 at different stages of the process of the present invention of non-conformally overcoating the nanometer-sized surface structures 320. Again, the elements of the structures 320 are separated by gaps 340. In FIG. 3a, an overcoat material 350 is directed onto the nanometer-sized surface structures 320 obliquely along a deposit direction 352. The oblique deposition angle θ is between zero and 90 degrees with respect to the orthogonal axis 370. Because of the oblique deposition angle, the overcoat material 350 is deposited mostly on a top portion 322 of each element of the nanometer-sized surface structures 320 with minimal deposition along sidewalls 324 of the nanometer-sized surface structures 320 facing the source of the depositing material. As illustrated, the overcoat material 350 will overhang the nanometer-sized surface structures 320 on the side facing the incoming deposition material.

In FIG. 3b, the deposition process has progressed further and the deposited portions of the overcoat material 350 on the top portions 322 of the nanometer-sized surface structures 320 are now touching each other. As illustrated, because the overcoat material 350 is being deposited uni-directionally, the growth of the depositing overcoat material 350 on the top portion 322 of each nanometer-sized surface structure 320 is asymmetric.

FIG. 3c illustrates a cross-sectional view of the nanometer-sized surface pattern where the deposition has been completed so as to form an overcoat layer 360. The interim asymmetric structures formed by deposited overcoat material 350 have now all merged to form a relatively flat and smooth surface. The desired flatness and smoothness of the overcoat layer are achieved by varying the deposition angle θ. The particular angle θ necessary will depend on the geometry of the particular nanometer-sized surface structures. More particularly, the necessary deposition angle θ will depend on the depth and the width of the gaps 340 between adjacent nanometer-sized surface structures. For example, a non-conformal overcoat of silicon oxide can be deposited over a surface bearing nanometer-sized surface structures having a periodicity of 150 nm with a gap spacing of 70 to 100 nm and depth to width aspect ratio of 10:1 using a sputter deposition method with a deposition angle θ between 5 to 10 degrees.

In addition, in order to form a continuous solid overcoat layer 360 that completely seals the gaps 340, the total overcoat thickness has to reach a critical value. Typical thickness-to-spacing ratios are in the 1:1 to 3:1 range.

The present invention can be practiced with any of the generally known physical vapor deposition or chemical vapor deposition methods as long as the deposition material has the directional characteristics. Examples of physical vapor deposition methods are sputtering and molecular beam epitaxy. Examples of chemical vapor deposition methods are plasma assisted (enhanced) chemical vapor deposition, photo chemical vapor deposition, laser chemical deposition, and chemical beam epitaxy. The details of measuring and controlling the deposition angles in each of these illustrative deposition methods are generally known in the art and they need not be discussed here.

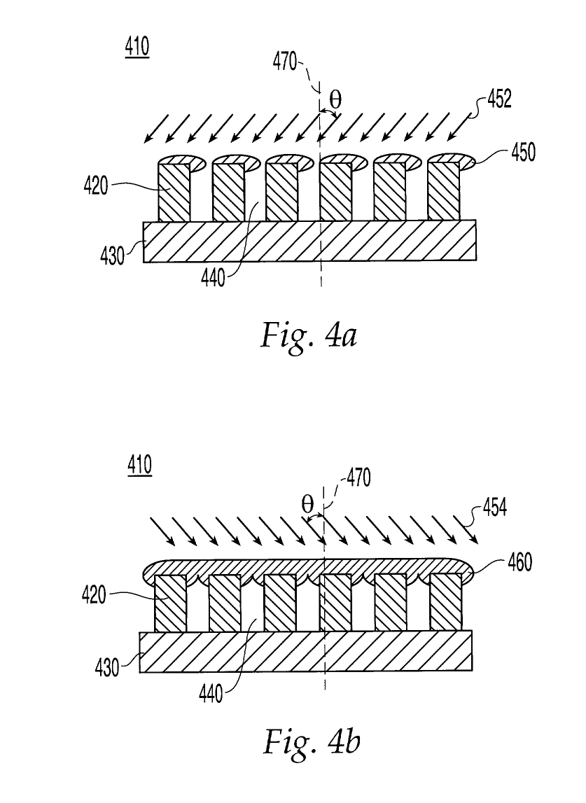

If desired, a better overcoat flatness and surface finish can be achieved by depositing the overcoat material bidirectionally. FIGS. 4a and 4b illustrate cross-sectional views of a device 410 having nanometer-sized surface structures 420 being non-conformally coated in two directions. Again, the elements of the structures 420 are separated by gaps 440. In this embodiment, an overcoat material 450 is directed onto the nanometer-sized surface structures 420 in a first deposition direction 452 at an oblique deposition angle θ as in the first embodiment of the process described in reference to FIGS. 3a-3c. The deposition angle θ is measured with respect to orthogonal axis 470 of the substrate 430. The overcoat material 450 is deposited in this first deposition direction 452 until the overcoat material 450 has partially bridged the gaps 440 between the nanometer-sized surface structures 420 as illustrated in FIG. 4a. The overcoat material 450 is then directed in a second deposition direction 454 that has the same deposition angle θ as the first deposition direction 452 but preferably from the opposite side of the orthogonal axis 470 of the substrate 430. The deposition of the overcoat material 450 in θ this second deposition direction 454 is continued until the overcoat material 450 has completely bridged the gaps 440 and form an overcoat layer 460.

Because of the symmetry in the deposition process, the resulting overcoat layer 460 exhibits better flatness and surface finish than the overcoat layer 360 formed by the unidirectional non-conformal deposition described in reference to FIGS. 3a-3c.

Alternatively, a second overcoat material (not shown) different from the overcoat material 450 may be used for the deposition in the second deposition direction 454. The resulting overcoat layer will then have a composite structure.

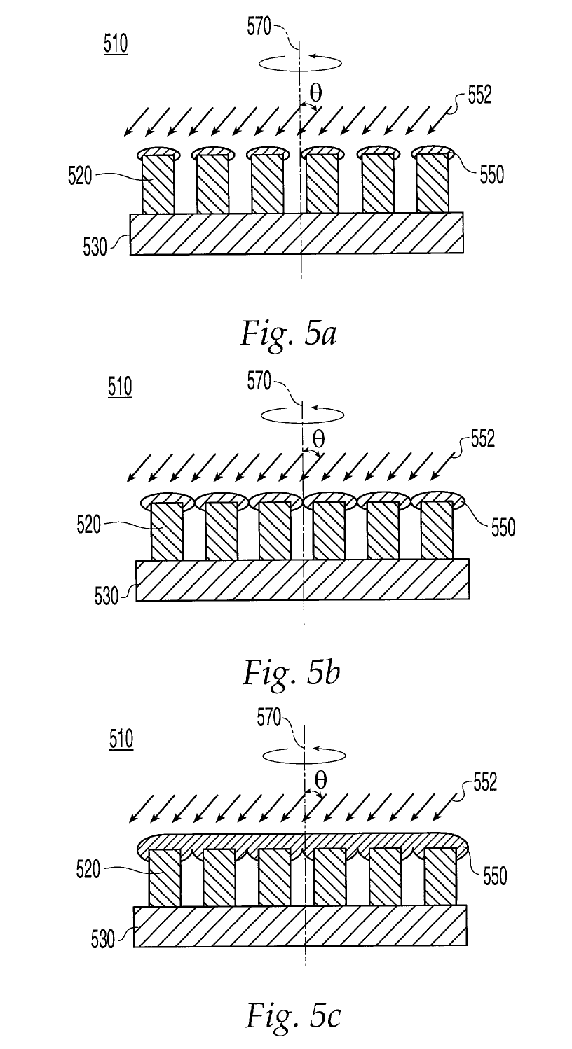

A similar improvement in the flatness and the surface finish of the overcoat layer may be achieved by another embodiment of the present invention which is illustrated in FIGS. 5a-5c. Again, a device 510 has nanometer-sized surface structures 520 formed on a substrate 530. In this embodiment, the substrate 530 is rotated about its orthogonal axis 570 while an overcoat material 550 is directed in deposition direction 552 at the deposition angle θ. Because of the radial symmetry in the process, the overcoat material 550 is deposited on the top portions of the nanometer-sized surface structures 520 in a symmetrical manner as illustrated in FIG. 5a. As the deposition process progresses, the deposited overcoat material 550 on top of the nanometer-sized structures 520 will extend evenly in all directions until the deposited overcoat material 550 from adjacent nanometer-sized structures 520 meets as illustrated in FIG. 5b. The deposition process is continued until a sufficient amount of the overcoat material 550 is deposited to form a substantially flat overcoat layer 560 having a desired surface finish as illustrated in FIG. 5c.

Thus, the method of the present invention provides a number of options for depositing an overcoat layer onto nanometer-sized surface structures. One or more of the embodiments of the present invention described above may be utilized to select the suitable deposition method for particular nanometer-sized surface structures. For example, the rotational deposition method may not be suitable for nanometer-sized surface structures having certain patterns that lack radial symmetry, such as the surface structure illustrated in FIG. 1c, since the rotational deposition method would deposit the overcoat material inside the gaps between the nanometer-sized surface structures. But the rotational deposition method is better suited for depositing an overcoat layer over the nanometer-sized surface structures illustrated in Figures la and lb.

The overcoat layer is not only used to protect the surface structures of a particular device but the overcoat layer may also be configured to modify or enhance the device's performance. This is achieved by carefully selecting the overcoat layer's structure, the number of layers within the overcoat layer, the material properties, and the particular deposition methods, etc. In optics applications, in particular, the performance parameters that may be enhanced include, but are not limited to, reflectivity, transmittance, operating bandwidth, acceptance angle, resonance, etc. of an optical component. In contrast, for surface protection purposes, materials with high hardness are desirable. Thus, selecting the appropriate overcoat material can be crucial for achieving the desired optical performance and surface durability.

In optics applications, it may be particularly desirable to deposit an overcoat layer having a multilayered structure. In such applications, after the first overcoat layer is non-conformally deposited utilizing one of the embodiments of the deposition process described above, additional layers of overcoat material are deposited on the first overcoat layer. The additional overcoat layers need not be deposited using the deposition process of the present invention since the subsequent layers are deposited onto a continuous and substantially flat first overcoat layer. One such application is the formation of optical coatings having multiple layers with indices of refraction that alternate in a low-high-low-high manner. Advantageously, materials with low optical losses and large differences in an optical index are used in such applications. Typical materials for optical uses are cerium oxide, hafnium oxide, silicon oxide, magnesium oxide, magnesium fluoride, and titanium oxide.

In some applications, one or more seed material may be provided at the interface between the nanometer-sized surface structures and the overcoat layer to provide enhancements such as improved adhesion between the nanometer-sized surface structures and the overcoat material, a diffusion barrier, or a corrosion barrier, etc. The seed material may be provided in a single or multiple layers and it may be a metallic or a dielectric material suitable for the particular application.

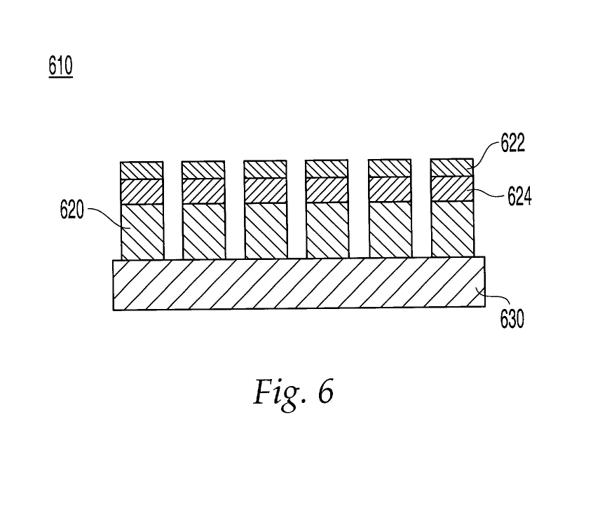

The seed material may be incorporated into the nanometer-sized surface structures as illustrated in FIG. 6. Again, a device 610 has nanometer-sized surface structures 620 formed on a substrate 630. One or more layers 622, 624 of a seed material are provided as part of the nanometer-sized surface structures 620. In this example, the seed material layers 622, 624 are deposited onto the nanometer-sized surface structures during the fabrication process for the nanometer-size surface structures themselves. One or more overcoat layers can be deposited onto this structure using any one of the various embodiments of the present invention described above.

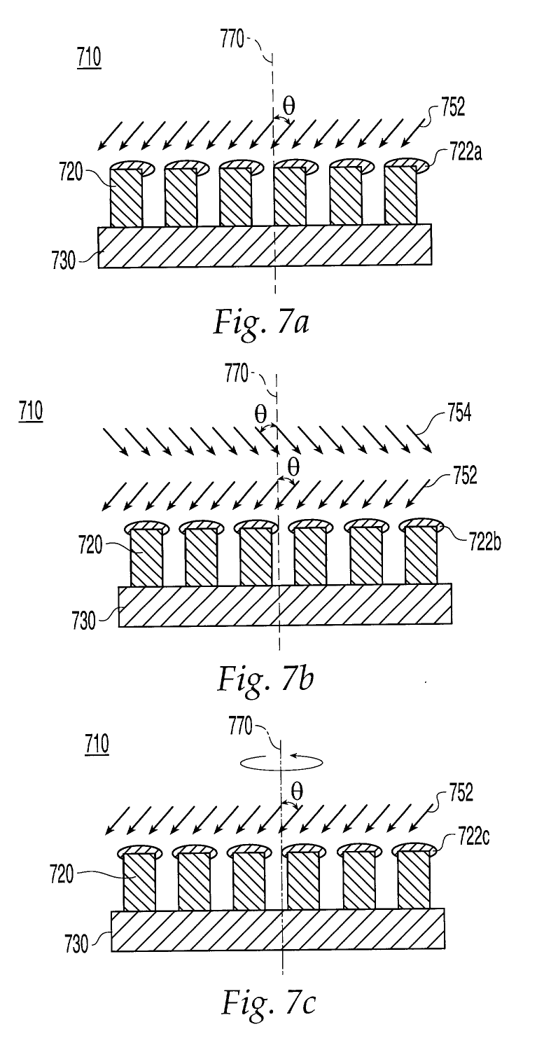

Alternatively, the one or more seed layers may be deposited onto the nanometer-sized surface structures using the non-conformal deposition process of the present invention before the overcoat layer is deposited. FIGS. 7a-7c illustrate the three alternative methods of depositing a seed layer onto a device 710 having nanometer-sized surface structures 720 using the three embodiments of the non-conformal deposition process according to the present invention: the unidirectional deposition; the bidirectional deposition; and the rotational deposition, respectively.

In FIG. 7a, a seed material is directed onto the nanometer-sized surface structures 720 in the deposit direction 752 at a deposition angle θ, thereby forming a seed layer structure 722a. In FIG. 7b, the seed material is directed onto the nanometer-sized surface structures 720 first in the first deposit direction 752 and then in the second deposit direction 754, resulting in the symmetrical seed layer structure 722b. In FIG. 7c, the seed material is directed onto the nanometer-sized surface structures 720 in deposit direction 752 while the device 710 is rotated about the orthogonal axis 770 of the substrate 730, resulting in the symmetrical seed layer structure 722c.

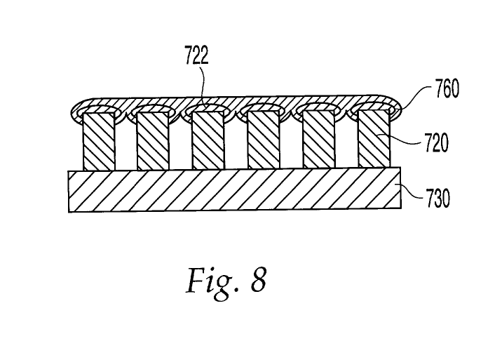

An overcoat layer may then be deposited over these interim structures using the non-conformal deposition method of the present invention. FIG. 8 illustrates an example of the final structure where an overcoat layer 760 is deposited over the interim structures of FIGS. 7b or 7c.

It will be obvious to one of ordinary skill in the art that the different embodiments of the non-conformal deposition methods described above may be used individually but they may also be practiced in combination on a given surface to produce one or more desired overcoat layers or seed layers.

Many modifications and variations are possible in view of the above teachings. The embodiments were chosen and described in order to best explain the principles of the invention and its practical applications, to thereby enable others skilled in the art to best utilize the invention and various embodiments with various modifications as is suited to the particular use contemplated. It is intended that the scope of the invention be defined by the appended claims and their equivalents.

I claim:

1. A method of forming an overcoat over a surface having nanometer-sized surface structures, where the nanometer-sized surface structures are spaced apart at regular intervals with gaps between the nanometer-sized surface structures, comprising:
directing an overcoat material onto the nanometer-sized surface structures in a deposition direction at an oblique angle with respect to the orthogonal axis of the surface bearing the nanometer-sized structures until the overcoat material forms a continuous layer of overcoat material bridging the gaps between the nanometer-sized surface structures without filling the gaps.

2. A method according to claim 1, wherein the oblique angle is between zero and 90 degrees.

3. A method according to claim 1, further comprising:
depositing at least one additional overcoat material on top of the continuous layer of overcoat material bridging the gaps.

4. A method according to claim 1, further comprising:
depositing at least one seed material layer onto the nanometer-sized surface structures before depositing the overcoat material.

5. A method according to claim 4, wherein the at least one seed material is a metal.

6. A method according to claim 4, wherein the at least one seed material is a dielectric material.

7. A method according to claim 1, wherein the overcoat material is selected from any one of cerium oxide, hafnium oxide, silicon oxide, magnesium oxide, magnesium fluoride, and titanium oxide.

8. A method of forming an overcoat over a surface having nanometer-sized surface structures, where the nanometer-sized surface structures are spaced apart at regular intervals with gaps between the nanometer-sized surface structures, comprising:
directing a first overcoat material onto the nanometer-sized surface structures in a first deposition direction at an oblique angle with respect to the orthogonal axis of the surface bearing the nanometer-sized structures until the first overcoat material has at least partially bridged the gaps between the nanometer-sized surface structures; and
directing a second overcoat material onto the first overcoat material in a second deposition direction at the oblique angle with respect to the orthogonal axis of the surface bearing the nanometer-sized structures until the first and second overcoat materials form a continuous layer of overcoat materials bridging the gaps without filling the gaps.

9. A method according to claim 8, wherein the oblique angle is between zero and 90 degrees.

10. A method according to claim 8, wherein the first overcoat material and the second overcoat material are the same material.

11. A method according to claim 8, further comprising:
depositing at least one additional overcoat material on top of the continuous layer of overcoat materials bridging the gaps.

12. A method according to claim 8, further comprising:
depositing at least one seed material layer onto the nanometer size surface structures before depositing the overcoat material.

13. A method according to claim 12, wherein the at least one seed material is a metal.

14. A method according to claim 12, wherein the at least one seed material is a dielectric material.

15. A method according to claim 8, wherein the overcoat material is selected from any one of cerium oxide, hafnium oxide, silicon oxide, magnesium oxide, magnesium fluoride, and titanium oxide.

16. A method of forming an overcoat over a surface having nanometer-sized surface structures, where the nanometer-sized surface structures are spaced apart at regular intervals with gaps between the nanometer-sized surface structures, comprising:
directing an overcoat material onto the nanometer-sized surface structures in a deposition direction at an oblique angle with respect to the orthogonal axis of the surface bearing the nanometer-sized structures while the nanometer sized-surface structures are rotated around the orthogonal axis of the surface bearing the nanometer-sized structures until the overcoat material forms a continuous layer of overcoat material bridging the gaps without filling the gaps.

17. A method according to claim 16, wherein the oblique angle is between zero and 90 degrees.

18. A method according to claim 16, further comprising:
depositing at least one additional overcoat material on top of the continuous layer of the overcoat material bridging the gaps.

19. A method according to claim 16, further comprising:
depositing at least one seed material layer onto the nanometer-sized surface structures at a deposit angle that is between zero and 90 degrees with respect to the orthogonal axis of the surface bearing the nanometer-sized structures before depositing the overcoat material.

20. A method according to claim 19, wherein the at least one seed material is a metal.

21. A method according to claim 19, wherein the at least one seed material is a dielectric material.

22. A method according to claim 16, wherein the overcoat material is selected from any one of cerium oxide, hafnium oxide, silicon oxide, magnesium oxide, magnesium fluoride, and titanium oxide.
